(19) United States
(12) Patent Application Publication
(10) Pub. No.: US 2008/0115867 A1
(43) Pub. Date: May 22, 2008

(54) Glycerin vehicle tire ballast

(76) Inventor: Dave Wayland, Enumclaw, WA (US)

Correspondence Address: DEAN A. CRAINE, SUITE 140, 400 - 112TH AVENUE NE, BELLEVUE, WA, 98004, US

(21) Appl. No.: 11/983,600

(22) Filed: Nov. 9, 2007

Related U.S. Application Data
(60) Provisional application No. 60/859,698, filed on Nov. 17, 2006.

(51) Int. Cl. B60C 19/00; C09K 3/00

(52) U.S. Cl. 152/154.1; 252/182.12

(57) ABSTRACT

A non-toxic, non-flammable, non-corrosive, bio-gradable tire ballast disclosed herein that comprises an aqueous composition containing 40% to 70% glycerin (w/v) with a relatively low freezing point (minus 38 degrees F.). The composition weighs 9.5 to 11 pounds per gallon and has a low freezing point (below, minus 38 degrees F.) At the temperatures minus 38 degrees F. or above, the composition flows easily into the valve stem using a liquid ballast pump, also referred to as a calcium pump. A suitable anti-corrosive chemical may be added to the composition to prevent rust inside the tire. In the preferred embodiment, the tire is filled approximately 40% to 75% full with the composition.

This is a utility patent application which claims benefit of U.S. Provisional Application No. 60/859,698 filed on Nov. 17, 2006.

### BACKGROUND OF THE INVENTION

1. Field of the Invention

This invention relates to vehicle tire ballasts, and more particularly to tire ballasts that are safe non-corrosive, rust resistant and bio-degradable.

2. Description of the Related Art

Pneumatic tires filled with a liquid composition which serves as a ballast to improve traction are well known. Ideally, the liquid composition should have a suitable viscosity so that it can be easily pumped into and out of the tire through the tire's valve. Typically, the tire is filled approximately 70% with the liquid composition. The tire is first rotated so that the tire valve is rotated to the 12 o'clock position. The liquid composition is then pumped into the tire until a back stream of liquid composition begins to flow out of the tire valve. When a continuous back stream flows outward from the valve, the worker knows that the tire is filled approximately 70% with liquid composition. The tire is then filled with air to 15 to 18 lbs. of pressure.

One problem with some liquid tire ballast compositions used today is that foam may be created inside the tire as the liquid composition is being added. Gradually, the foam builds up inside the tire and eventually begins to flow outward through the tire valve. When this occurs, the filling process with the liquid composition must be temporarily discontinued to allow the foam to subside. Once the foam has subsided, the filling process may be continued until a back stream of liquid composition flows outward from the valve.

The tire ballast liquid compositions are usually sold in large containers to tire selling companies or to heavy equipment dealers. The liquid compositions are pumped from large containers that include a tube or pipe that extends into the large container. The end of the tube or pipe is usually disposed near the bottom of the large container so that most of the liquid composition can be pumped from the container before refilling. Because the liquid compositions may be stored inside large containers for several months and exposed to different temperatures, it is important that the liquid compositions remain in a mixture state at all times.

### SUMMARY OF THE INVENTION

It is an object of the present invention to provide liquid tire ballast that is safe to handle non-corrosive, bio-degradable, and relatively inexpensive.

It is another object of the present invention to provide such liquid tire ballast that has a viscosity similar to water, and does not foam when being pumped into and out of a tire.

It is a further object of the present invention to provide such liquid tire ballast that remains in a mixture state and does not settle into different layers when stored in large containers for long periods and under different temperatures.

These and other objects of the invention are met by the non-toxic, non-flammable, non-corrosive, bio-degradable tire ballast disclosed herein that comprises an aqueous composition containing 40% to 70% glycerin (w/v). The composition weighs 9.5 to 11 pounds per gallon and has a relatively low freezing point (below minus 38 degrees F.) At temperatures minus 38 degrees F. or above, the composition is relatively stable and remains in a mixture state. Also, at such temperatures the composition flows easily into the tire's valve stem using a standard liquid pump using in the tire industry. Because glycerin is an anti-corrosive, an anti-corrosive chemical is not needed.

In the preferred embodiment, the tire is filled until approximately 75% full with the composition. Because no foam is created in the tire, the filling process is faster and easier then with other liquid tire ballast composition found in the prior art.

### DESCRIPTION OF THE DRAWINGS

FIG. 1 is a front view of a vehicle tire approximately 75% filled with tire ballast liquid composition.

### DESCRIPTION OF THE PREFERRED EMBODIMENT(S)

Referring to the accompanying Fig., there is disclosed a non-toxic, non-flammable, non-corrosive, bio-degradable tire ballast disclosed herein that comprises an aqueous composition 20 containing approximately 40% to 70% glycerin (w/v) with a relatively low freezing point (minus 70 degrees F.). The composition 20 weighs 9.5 to 11 pounds per gallon and has a low freezing point (below minus 38 degrees F.)

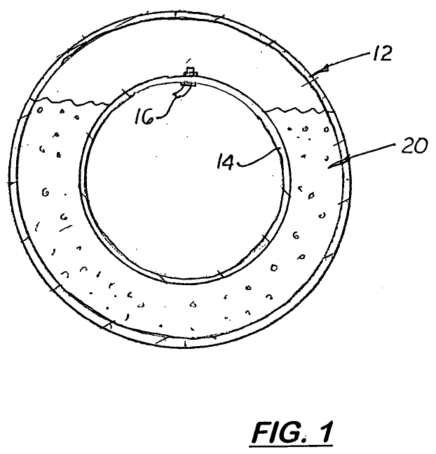

FIG. 1 shows a standard pneumatic tire 12 mounted in a rim 14. Attached to the rim 14 is a standard two way tire valve 16. The composition 20 is stored in a large storage container which is normally poured from the container into the tire valve 16.

At the temperatures minus 38 degrees F. or above, the composition 20 flows easily into the tire valve 16 of a tire 12 using a liquid ballast pump. In the preferred embodiment, the tire is filled until 40% to 75% full with the composition 20 depending on the type of tire and the tire manufacturer's recommendation (bias ply tires are filled up to 70% full, while radial tires are normally filled up to 40% full).

In the preferred embodiment, technical grade glycerin (99.6% wt) is used in the composition 20. It should be understood however that other grades, such as, partially refined (soy or cotton seed base 75% to 95%) or glycerin USP may be used.

In compliance with the statute, the invention described herein has been described in language more or less specific as to structural features. It should be understood however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A liquid tire ballast composition comprising an aqueous mixture of 40% to 70% glycerin (w/v).

2. The tire ballast composition, as recited in claim 1, wherein said glycerin is technical grade glycerin.

3. A vehicle wheel comprising:
a. a rim and a pneumatic tire mounted on the rim; an,
b. a liquid tire ballast made of 40% to 70% glycerin dispensed into said tire.

4. The vehicle wheel, as recited in claim 3, wherein said glycerin is technical grade glycerin.

5. A method for ballasting a pneumatic tire, comprising the following steps:
a. selecting a pneumatic tire mounted on a rim, said tire includes an air valve so that said tire may be filled with air; and,
b. filing said tire with a composition that includes 40% to 70% glycerin until said tire is approximately 40% to 75% filled with said composition.

6. The method, as recited in claim 5, wherein said glycerin is technical grade glycerin.
